(19) United States
(12) Patent Application Publication
(10) Pub. No.: US 2016/0338315 A1
(43) Pub. Date: Nov. 24, 2016

(54) Pet Scratcher, Hideout and Carrier

(71) Applicant: Worldwise, Inc., San Rafael, CA (US)

(72) Inventors: Charles Floyd, Oakland, CA (US); Sara Paculdo, Novato, CA (US); Aimee Diskin, Napa, CA (US)

(21) Appl. No.: 14/716,863

(22) Filed: May 19, 2015

(51) Int. Cl. A01K 1/02; A01K 15/02; A01K 1/03

(52) U.S. Cl. CPC A01K 1/029; A01K 1/03; A01K 15/024; A01K 1/0245

(57) ABSTRACT

A cat scratcher, hideout and carrier device. The device includes a base, sidewalls appended to the base and a handle region forming an interior space. The base has a first surface external to the interior space and a second surface residing within the interior space. A cat scratcher is supported by the second surface of the base for providing a scratching surface within the interior space. At least a portion of one of the sidewalls is at least partially and selectively detachable from the other side walls to expose the interior space, the interior space being completely enclosed when all of the sidewalls are attached to one another.

### TECHNICAL FIELD

The present invention involves a cat scratcher, hideout and carrier device that not only satisfies a cat's need to scratch and its need for seclusion but also is an effective carrier which eliminates hesitancy that cats exhibit when encouraged to enter into an enclosed carrier for transport.

### BACKGROUND OF THE INVENTION

It is well known that domestic cats exhibit certain idiosyncrasies which often times present challenges to the pet owner. One of such challenges is faced each time the pet owner attempts to transport his or her pet in a carrier. Cats are reluctant to enter a confined space, particularly if it feels trapped and cannot anticipate what will occur once confinement is achieved. Pet owners try to coax cats into confined carriers with treats and attractants but, regardless of one's creativity, encouraging a cat to voluntarily enter a carrier is not something that a pet owner looks forward to.

Another idiosyncrasy of a domestic cat is its need to scratch as part of its natural instinctive character. If a dedicated scratching surface is not provided, domestic cats would generally satisfy their need to scratch by turning to furniture, curtains and other articles which can be substantially damaged as a consequence. Often times, pet cats will not only climb over furniture, specifically upholster chairs and sofas, but will use such furniture and carpeting to condition their claws through deliberate repeated clawing, pulling and tearing actions specifically with their forepaws. This clawing activity appears to be an irresistible natural impulse for cats and can be the source of great aggravation to the pet owner.

In addition, cats of all kinds require and thus seek out places for seclusion. Cats need a cloistered safe haven where they can relax knowing that they need not fear intrusion by any human or animal which could cause of harm.

It is thus an object to the present invention to take advantage of a cat's idiosyncrasies in order to provide a cat scratcher, hideout and carrier device which satisfies a cat's need to scratch and for seclusion and, in doing so, result in a carrier that a cat would readily enter without coaxing.

These and further objects will be readily apparent when considering the following disclosure and appended claims.

### SUMMARY OF THE INVENTION

A cat scratcher, hideout and carrier device comprising a base, sidewalls appended to said base and a handle region forming an interior space, said base having a first surface external to said interior space and a second surface residing within said interior space, a cat scratcher supported by said second surface of said base for providing a scratching surface within said interior space and wherein at least a portion of one of said sidewalls being at least partially and selectively detachable from other side walls to expose said interior space, said interior space being completely enclosed when sidewalls remain attached to one another.

A cat scratcher, hideout and carrier device comprising a square or rectangular base, four sidewalls appended to said base and four extensions emanating from said four sidewalls creating a handle region and, together, forming an interior space, said square or rectangular base having a first surface external to said interior space and a second surface residing within said interior space, a square or rectangular cat scratcher sized to substantially cover and be supported by said second surface of said square or rectangular base for providing a scratching surface within said interior space, a first of said four sidewalls being at least partially and selectively detachable from other side walls by forming a crease within said first of said sidewalls to create an upper region and lower region of said first of said sidewalls such that when said first of said sidewalls is detached from said other side walls, said upper region folds along said crease to reside adjacent to said lower region of said first of said sidewalls to alternatively expose said interior space to create a hideout for a cat and to enclose said interior space to create a carrier device for a cat.

### BRIEF DESCRIPTION OF THE FIGURES

FIG. 1 is a perspective view of the cat scratcher, hideout and carrier device of the present invention with its interior space completely enclosed.

FIG. 2 is a perspective view of the cat scratcher, hideout and carrier device of FIG. 1 in a second state exposing the interior of the device.

FIG. 3 is a perspective view of a scratch pad for use in the cat scratcher, hideout and carrier device of the present invention.

FIG. 4 is a cross-sectional side view of the base portion of the cat scratcher, hideout and carrier device of the present invention.

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

Cat scratcher, hideout and carrier device 10 is shown, in FIG. 1 in a first state, that is, with sidewalls 12, 13, 14 and 15 appended to one another enclosing interior space 40. Extending from sidewalls 12, 1314 and 15 is handle region 16 which includes extensions 18, 19, 23 and 24 which, in this embodiment, completes the enclosure of interior space 40 by inserting wings 25 and 26 within openings configured within extensions 23 and 24 as shown.

As best illustrated in FIG. 4, cat scratcher, hideout and carrier device10 is further provided with base 11 having first surface 41 external to interior space 40 and second surface 42 residing with the interior space. It is envisioned that, in general use, base 11 will reside upon horizontally extending support surface 5 such that sidewalls 12, 13, 14 and 15 extend vertically therefrom if the sidewalls and base are, as depicted, orthogonal to one another.

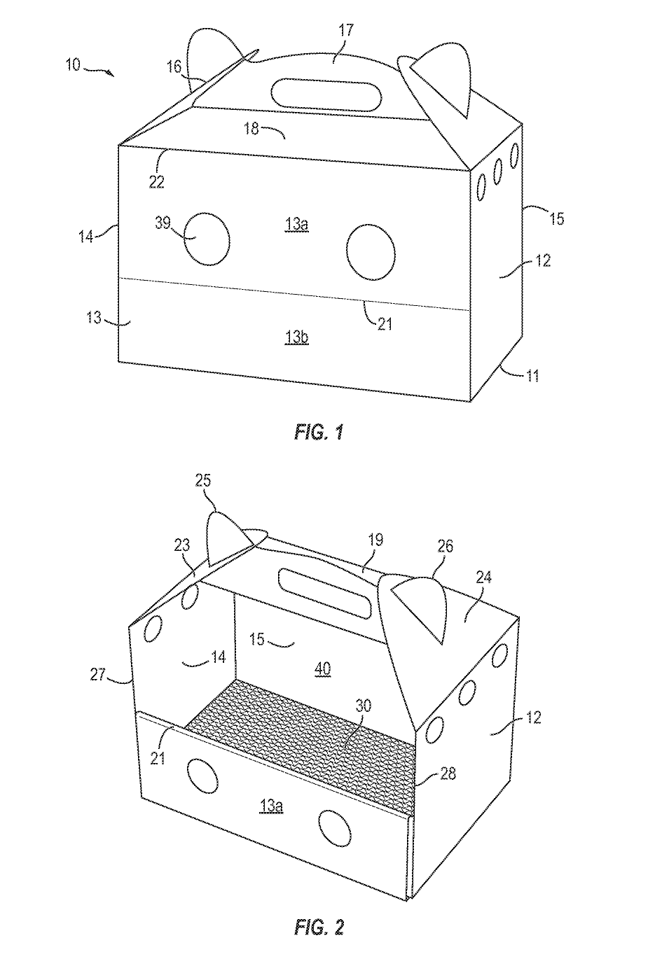

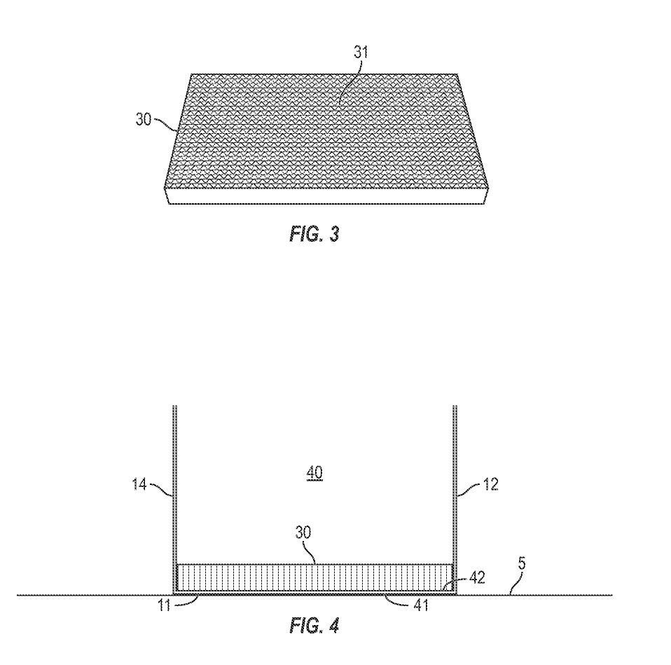

As noted previously, in promoting use of device 10 as a carrier, the pet must feel comfortable in residing within interior space 40. In order to promote this objective, device 10 also operates as a scratcher and hideout. In this regard, reference is made to FIGS. 2, 3 and 4.

In turning first to FIG. 2, it is noted that sidewall 13 is provided with crease 21 separating subparts 13a and 13b from one another. In converting cat scratcher, hideout and carrier device 10 from its carrier configuration of FIG. 1 to that of FIG. 2, subpart 13a is separated from adjacent sidewalls 12 and 14 along serrated edges 27 and 28 to enable subpart 13a to rotate along crease 21 so that it lies against subpart 13b. Ideally, within handle region 16, extension 18 can also fold along crease line 22 to reside against subpart 13b in order to facilitate entrance and egress of a cat within interior space 40. Again, this is carried out by providing sidewall 13 with a crease between subpart 13a and extension 18 of handle region 16 such that upon subpart 13a being detached from adjacent sidewalls 12 and 14 along serrated edges 27 and 28, extension 18 of handle region 16 will be fold along crease 22 to alternatively expose interior space 40 to create a hideout and scratcher for a cat and to enclose interior space 40 to create the carrier configuration of FIG. 1.

Preferably, base 11 is substantially rectangular or square such that four sidewalls 12, 13, 14 and 15, together with handle region 16 fully enclose interior space 40. Base 11 is sized to receive scratcher 30 which, although can be of any generally recognized material such as carpet, sisal and the like, it is preferred that scratcher 30 be comprised of corrugated cardboard as that not only results in an ideal scratching surface but standard sized scratchers 30 can be offered to the pet owner as replacements once a scratcher is degraded to the point where replacement is appropriate.

In summary, it is envisioned that a pet owner would introduce his or her pet to cat scratcher, hideout and carrier device 10 in the orientation depicted in FIG. 2. Cats will generally gravitate toward such a device through general curiosity, the need to engage a scratching surface and to seek out a quiet place for seclusion. In doing so, the cat will find it most comfortable to enter and leave interior space 40 without trepidation or hesitancy. When the need arises to transport the cat to a remote location, such as for a veterinary visit, the pet owner will wait until the cat enters interior space 40 or encouraged to do so by the owner as the cat will not associate interior space 40 with anything but a place for scratching and seclusion. Upon entering interior space 40, subpart 13a and extension 18 can be rotated about creases 21 and 22, respectively, for completely enclosing device 10 as in its FIG. 1 orientation. Handle 17 is provided to enable the pet owner to carry his or her pet in cat scratcher, hideout and carrier device 10 noting that, as a preferred embodiment, the device is provided with one or more openings 39 for ventilation.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like. Therefore, the above description and illustration should not be considered as limiting the scope of the invention, which is defined by the appended claims.

What is claimed is:

1. A cat scratcher, hideout and carrier device comprising a base, sidewalls appended to said base and a handle region forming an interior space, said base having a first surface external to said interior space and a second surface residing within said interior space, a cat scratcher supported by said second surface of said base for providing a scratching surface within said interior space and wherein at least a portion of one of said sidewalls being at least partially and selectively detachable from other side walls to expose said interior space, said interior space being completely enclosed when sidewalls remain attached to one another.

2. The cat scratcher, hideout and carrier device of claim 1 wherein said one of said sidewalls is provided with a crease such that upon said portion thereof being detached from said other side walls is foldable along said crease to alternatively expose said interior space to create a hideout device for a cat and enclose said interior space to create a carrier device for a cat.

3. The cat scratcher, hideout and carrier device of claim 1 further comprising at least one opening within said sidewalls or handle region for ventilating said interior space.

4. The cat scratcher, hideout and carrier device of claim 1 wherein said base is square or rectangular and said four sidewalls extend therefrom.

5. The cat scratcher, hideout and carrier device of claim 1 wherein said sidewalls extend orthogonally from said base.

6. The cat scratcher, hideout and carrier device of claim 5 further comprising a horizontal support surface for receipt of said base, said sidewalls extending vertically there from.

7. The cat scratcher, hideout and carrier device of claim 1 wherein a part of said handle region is removable from the remainder of the handle region when said at least a portion of one of said sidewalls is detached from said other side walls to expose said interior space.

8. The cat scratcher, hideout and carrier device of claim 7 wherein said one of said sidewalls is provided with a crease between said one of said side walls and said part of said handle region such that upon said portion of said one of said sidewalls being detached from said other side walls, said part of said handle region is selectively foldable along said crease to alternatively expose said interior space to create a hideout for a cat or to enclose said exterior space to create a carrier device for a cat.

9. A cat scratcher, hideout and carrier device comprising a square or rectangular base, four sidewalls appended to said base and four extensions emanating from said four sidewalls creating a handle region and, together, forming an interior space, said square or rectangular base having a first surface external to said interior space and a second surface residing within said interior space, a square or rectangular cat scratcher sized to substantially cover and be supported by said second surface of said square or rectangular base for providing a scratching surface within said interior space, a first of said four sidewalls being at least partially and selectively detachable from other side walls by forming a crease within said first of said sidewalls to create an upper region and lower region of said first of said sidewalls such that when said first of said sidewalls is detached from said other side walls, said upper region folds along said crease to reside adjacent to said lower region of said first of said sidewalls to alternatively expose said interior space to create a hideout for a cat and to enclose said interior space to create a carrier device for a cat.

10. The cat scratcher, hideout and carrier device of claim 9 wherein a crease is provided between the first of said sidewalls and one of said four extensions such that upon detachment of said first of said sidewalls from said other side walls, said one of said four extensions folds along said crease to alternatively expose said interior space to create a hideout for a cat and enclose said interior space to create a carrier for a cat.
